(19) United States
(12) Patent Application Publication
(10) Pub. No.: US 2019/0172162 A1
(43) Pub. Date: Jun. 6, 2019

(54) Home/property equity surrender funds

(71) Applicant: Terry Smith, SR., Pittsburg, CA (US)

(72) Inventor: Terry Smith, SR., Pittsburg, CA (US)

(21) Appl. No.: 15/732,325

(22) Filed: Dec. 6, 2017

(51) Int. Cl. G06Q 50/16; G06Q 40/02

(52) U.S. Cl. CPC G06Q 50/163; G06Q 40/02

(57) ABSTRACT

The Home/Property Equity Surrender Funds concept is the ability for the property owner to receive funds from a financial institution based on equity, while not incurring a loan or interest being charged and funds received will be adjusted at the time of property sale, transfer or repayment.

In general—This process invention entails the ability for a home/property owner to receive funds based on the equity in their property without incurring a loan, or interest on the funds. There is no age requirement with respect to qualifying for the funds.

### SPECIFICATION DETAILS

The funds received by the owner are not a loan
There is no interest charged on the funds received
There is no qualifying age
Satisfaction of the funds is not by way of traditional means, however are accounted for at the time of sale, transfer and/or replenishment of equity
Credit support of financial status is not required
There can be multiple surrender fund transactions, as approved by the financial institution
There must be a valuation of the property from which the fund amount is to be determined
In the absence of transfer sale of the property, the replenished funds will again be added as equity to the property—or treated as value to the property in the event of underwater property
In the event the financial institution reduces eligible funds as a fee to service, the fee is a one-time event for each surrender

### BACKGROUND OF THE INVENTION

This invention pertains to the real estate field and investments.

Though there are numerous and distinct differences, the Reverse Mortgage concept has remote hints of similarity.

### SUMMARY OF THE INVENTION

This equity process is advantageous in that owning individuals will be able to access funds contained in their property—without requirements concerning personal financial qualification, age requirements, securing a loan or interest against said property and without the issue of losing the property in the event sale or transfer is later an undesired choice.

1. The substance of this Home/Property Equity Surrender Funds concept is an entirely new and distinct method of utilizing the equity in the properties owned.
Equity in owned properties would be accessible without the need to formally again qualify for a loan upon which the equity is solely the financial gain of the owner.
